(19) United States
(12) Patent Application Publication
(10) Pub. No.: US 2021/0224783 A1
(43) Pub. Date: Jul. 22, 2021

(54) Dynamic Financial Transaction Control Based on Peer-to-Peer Interactions

(71) Applicant: International Business Machines Corporation, Armonk, NY (US)

(72) Inventors: Jason Mathew, Austin, TX (US); Emma R. Tucker, Austin, TX (US); Amod Mukund Upadhye, Austin, TX (US); Erick C. Espinoza, Austin, TX (US); Jennifer Elizabeth Oliver, Austin, TX (US)

(73) Assignee: International Business Machines Corporation, Armonk, NY (US)

(21) Appl. No.: 16/748,863

(22) Filed: Jan. 22, 2020

(51) Int. Cl. G06Q 20/32; G06Q 20/22; G06Q 40/02; G06Q 20/40; G06N 20/00; G06N 5/04; G06F 40/295; G01S 19/51

(52) U.S. Cl. CPC G06Q 20/3224; G06Q 20/223; G06Q 40/02; G01S 19/51; G06N 20/00; G06N 5/04; G06F 40/295; G06Q 20/405

(57) ABSTRACT

A computer system, a computer program product, and a computer-implemented system are provided for selectively restricting fiscal transactions based on peer-to-peer (P2P) interaction events. NLP is leveraged to detect a future P2P interaction event, and historical records are leveraged to detect and use historical P2P interaction events and historical financial transactions to predict a fiscally related expenditure for the future P2P interaction event. Depending upon whether the predicted expenditure exceeds a spending control limit, action is taken to restrict the fiscal transaction(s).

### BACKGROUND

The disclosed embodiments relate to a computer system, a computer program product, and a method using artificial intelligence (“AI”) for dynamically providing an action to manage a fiscal transaction. In particular embodiments, the computer system, the computer program product, and the method apply AI for dynamically providing an action to selectively restrict a current or future transaction based on historical peer-to-peer (“P2”) interactions.

In the field of AI computer systems, natural language processing (“NLP”) systems process natural language based on acquired knowledge. NLP is a field of AI that functions as a translation platform between computer and human languages. More specifically, NLP enables computers to analyze and understand human language. Natural Language Understanding (NLU) is a category of NLP that is directed at parsing and translating input according to natural language principles. Examples of such NLP systems are the IBM Watson® artificial intelligent computer system and other natural language question answering systems.

To process natural language, the AI computer system may be trained with data derived from a database or corpus of knowledge. Machine learning (“ML”), which is a subset of AI, utilizes algorithms to learn from data and create foresights based on the data. AI refers to the intelligence when machines, based on information, are able to make decisions. Machine decision-making learning maximizes the chance of success in a given topic. AI is able to learn from a data set to solve problems and provide relevant recommendations.

AI is a subset of cognitive computing, which refers to systems that learn at scale, reason with purpose, and naturally interact with humans. Cognitive computing is a mixture of computer science and cognitive science. Cognitive computing utilizes self-teaching algorithms that use data, visual recognition, and NLP to solve problems and optimize human processes.

### SUMMARY

The embodiments disclosed herein include a computer system, a computer program product, and a method for using artificial intelligence (“AI”) to dynamically provide an action for controlling fiscal transactions, and in particular embodiments base the fiscal control on historical (past) peer-to-peer interaction events and historical financial transactions.

An aspect of a first embodiment provides a computer system including a processing unit operatively coupled to memory and an artificial intelligence (AI) platform in communication with the processing unit. The AI platform includes one or more tools to dynamically provide an action to selectively restrict a fiscal transaction. The AI platform includes a natural language (NL) manager to scrape a data source to monitor for and identify a future peer-to-peer (P2P) interaction event between a first peer entity and at least one second peer entity, to identify the second peer entity of the P2P interaction event, and to identify at least one historical P2P interaction event between the peer entities, wherein the first peer entity has access to a financial account. The AI platform further includes an AI manager to apply AI to associate the future P2P interaction event with the at least one historical P2P interaction event based on at least the identity of the at least one second peer entity, identify at least one historical financial transaction record associated with the at least one historical P2P interaction event between the peer entities, the at least one historical financial transaction record associated with at least one historical P2P interaction event and comprising at least one historical expenditure by the first peer entity, predict a future expenditure anticipated for the future P2P interaction event based on the at least one historical expenditure, and assess the predicted future expenditure with respect to a spending control limit. The AI platform further includes a director to selectively fiscally restrict the first peer entity from with respect to the financial account in connection with the future P2P interaction event responsive to the assessed prediction.

An aspect of a second embodiment provides a computer program product to selectively restrict a fiscal transaction. The computer program product includes a computer readable storage medium having program code embodied therewith. The program code is executable by a processor to leverage a national language processing (NLP) system for scraping a data source to monitor for and identify a future peer-to-peer (P2P) interaction event between a first peer entity and at least one second peer entity, to identify the second peer entity of the future P2P interaction event, and to identify at least one historical P2P interaction event between the peer entities, the first peer entity having access to a financial account. The program code further is executable to apply artificial intelligence (AI) to associate the future P2P interaction event with the at least one historical P2P interaction event based on at least the identity of the at least one second peer entity, identify at least one historical financial transaction record associated with the at least one historical P2P interaction event between the peer entities, the at least one historical financial transaction record associated with at least one historical P2P interaction event comprising at least one historical expenditure by the first peer entity, predict a future expenditure anticipated for the future P2P interaction event based on the at least one historical expenditure, and assess whether the predicted future expenditure anticipated for the future P2P interaction event exceeds a spending control limit. The program code further is executable to leverage a director to selectively fiscally restrict the first peer entity with respect to the financial account in connection with the future P2P interaction event responsive to the assessed prediction.

An aspect of a third embodiment provides a computer-implemented method including leveraging a national language processing (NLP) system for scraping a data source to monitor for and identify a future peer-to-peer (P2P) interaction event between a first peer entity and at least one second peer entity, to identify the at least one second peer entity, and to identify at least one historical P2P interaction event between the peer entities, the first peer entity having access to a financial account. The method further includes leveraging an artificial intelligence (AI) platform to associate the future P2P interaction event with the at least one historical P2P interaction event based on at least the identity of the at least one second peer entity, identify at least one historical financial transaction record associated with the at least one historical P2P interaction event between the peer entities, the at least one historical financial transaction record associated with at least one historical P2P interaction event and comprising at least one historical expenditure by the first peer entity, predict a future expenditure anticipated for the future P2P interaction event based on the at least one historical expenditure, and assess whether the predicted future expenditure anticipated for the future P2P interaction event exceeds a spending control limit. The method further includes leveraging a director to selectively fiscally restrict the first peer entity with respect to the financial account in connection with the future P2P interaction event responsive to the assessed prediction.

Other aspects of the invention, including machines, devices, products, code, systems, methods, and processes will become more apparent from the following detailed description of exemplary embodiments, taken in conjunction with the accompanying drawings.

### BRIEF DESCRIPTION OF THE SEVERAL VIEWS OF THE DRAWINGS

The drawings referenced herein form a part of the specification and are incorporated herein. Features shown in the drawings are meant as illustrative of only some embodiments, and not of all embodiments, unless otherwise explicitly indicated.

FIG. 1 depicts a system diagram illustrating an artificial intelligence (AI) platform computing system.

FIG. 2 depicts a block diagram illustrating artificial intelligence platform tools, as shown and described in FIG. 1, and their associated application program interfaces.

FIG. 3 depicts a flowchart illustrating an overall method for controlling fiscal transactions according to an exemplary embodiment.

FIGS. 4A and 4B depict a flowchart illustrating part of a method for controlling fiscal transactions according to an exemplary embodiment.

FIG. 5 depicts a flowchart illustrating part of a method for controlling fiscal transactions according to an exemplary embodiment.

FIG. 6 depicts a flowchart illustrating a part of a method for controlling fiscal transactions according to an exemplary embodiment.

FIG. 7 depicts a block diagram illustrating an example of a computer system/server of a cloud based support system, to implement the system, product, and processes described above with respect to FIGS. 1-6.

FIG. 8 depicts a block diagram illustrating a cloud computer environment.

FIG. 9 depicts a block diagram illustrating a set of functional abstraction model layers provided by the cloud computing environment.

### DETAILED DESCRIPTION OF EXEMPLARY EMBODIMENTS

It will be readily understood that the components of the present embodiments, as generally described and illustrated in the Figures herein, may be arranged and designed in a wide variety of different configurations. Thus, the following detailed description of the embodiments of the apparatus, system, method, and computer program product of the present embodiments, as presented in the Figures, is not intended to limit the scope of the embodiments, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiment. Thus, appearances of the phrases “a select embodiment,” “in one embodiment,” or “in an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of products, systems, and processes that are consistent with the embodiments as claimed herein.

Consumers are heavily influenced by those persons with whom we interact on a day-to-day basis. Many choices that consumers make are a direct result of interactions with specific individuals (or peers) that exert great influence over consumer decision-making. That influence can be positive or negative, depending upon the particular peer. Negative influences can have adversely affect consumer behavior, especially financial transaction decisions.

It is, therefore, an object to embodiments disclosed herein to provide a system, a software program product, and a method for dynamically controlling or managing transactions, which in one embodiment includes financial transactions, at a future peer-to-peer (“P2P”) interaction event between a first peer entity and at least one second peer entity based on one or more transactions at one or more past (historical) P2P interaction events between the first and second peer entities.

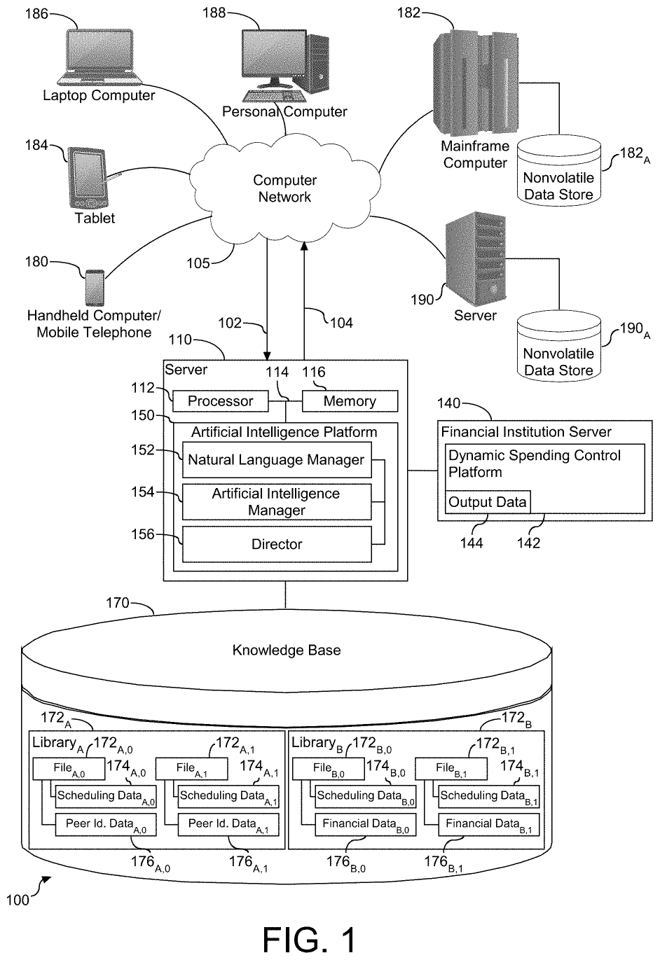

Referring to FIG. 1, a schematic diagram of an artificial intelligence (AI) platform computing system (100) is depicted. The system (100) is configured to dynamically provide an action for controlling (e.g., restricting or declining) fiscal transactions, including but not limited to financial transactions. As shown, a server (110) is provided in communication with a plurality of computing devices (180), (182), (184), (186), (188), and (190) across a network connection (105). The server (110) is configured with a processing unit (112) in communication with memory (116) across a bus (114). The server (110) is shown with an AI platform (150) for cognitive computing, including natural language processing (NLP) and Natural Language Understanding (NLU), across the network (105) from one or more of the computing devices (180), (182), (184), (186), (188), and (190). More specifically, the computing devices (180), (182), (184), (186), (188), and (190) communicate with each other and with other devices or components via one or more wired and/or wireless data communication links, where each communication link may comprise one or more of wires, routers, switches, transmitters, receivers, or the like. In this networked arrangement, the server (110) and the network (105) enable communication detection, recognition, and resolution via one or more network connections, such as (102) and (104). Other embodiments of the server (110) may be used with components, systems, sub-systems, and/or devices other than those that are depicted herein.

The AI platform (150) is shown in FIG. 1 configured with tools to dynamically manager one or more transaction or transaction related actions. The tools include, but are not limited to, a natural language (NL) manager (152), an AI manager (154) and a director (156). The AI platform (150) may receive input (102) from the network (105) and leverage a data source (170), also referred to herein as a corpus or knowledge base (170), of electronic documents and files, or other data, content, or other possible sources of input or information to support and enable the dynamic transaction control. As shown, the data source (170) is configured with electronic files organized or assigned to one or more libraries. In one embodiment, one or more of the libraries may be distributed across the network (105). Accordingly, the AI platform (150) and the corresponding tools (152), (154), and (156) are operatively coupled to the knowledge base (170) and the corresponding one or more libraries.

As shown herein, the knowledge base (170) is configured with libraries populated with files. In the example depicted in FIG. 1, the knowledge base (170) includes two libraries, specifically a first Library_{A} (172_{A}) and a second Library_{B} (172_{B}). In an embodiment, the first Library_{A} (172_{A}) may be comprised of files personal to a first peer entity, such as in association with a calendar, email account, messaging account, etc. In another embodiment, the first Library_{A} (172_{A}) may be comprised of files from a social media site, such as files associated with posts, personal messages, etc. by or to the first peer entity. The second Library_{B} (172_{B}) in the illustrated embodiment is associated with financial records, such as those stored in a financial account, for example, a banking account, debit account, a credit card account, a savings account, a brokerage account, a financial app (e.g., MINT, QUICKEN), a combination thereof, etc.

Although two libraries, Library_{A} (172_{A}) and Library_{B} (172_{B}), are shown, this quantity is for illustrative purposes and should not be considered limiting. For example, the first Library_{A} (172_{A}) and the second Library_{B} (172_{B}) can be a single library. Alternatively, the first Library_{A} (172_{A}) and/or the second Library_{B} (172_{B}) can comprise multiple libraries. For example, the first Library_{A} (172_{A}) may comprise multiple libraries and associated files for a calendar, an email account, a social media account, respectively. The second Library_{B} (172_{B}) may comprise multiple libraries and associated files for different financial accounts, such as a bank account a credit card account, a brokerage account, etc.

As shown in FIG. 1, the first Library_{A} (172_{A}) includes two files, shown as File_{A,0} (172_{A,0}) and File_{A,1} (172_{A,1}), and the second Library_{B} (172_{B}) is shown with two files, shown as File_{B,0} (172_{B,0}) and File_{B,1} (172_{B,1}). Although each library is shown with two files, this quantity is for illustrative purposes and should not be considered limiting. In an exemplary embodiment, the files of the first Library_{A} (172_{A}) are subject to processing, including NLP, to assess peer-to-peer (P2P) interaction event information (or data), such as scheduling information (or data) and peer identification. The second Library_{B} (172_{B}) containing financial information (or data) is also subject to processing, optionally including NLP, to assess financial transaction history for financial expenditure information relevant to the historical P2P interaction events. At times the terms information and data are used interchangeably herein.

According to an embodiment, the first Library_{A} (172_{A}) of FIG. 1 includes files for future (upcoming) events and past (historical) events. In an embodiment, the individual files are, for example, calendar entries, communication exchanges (e.g., text or email) with a peer, social media posts, etc. For explanatory purposes, a first file, e.g. File_{A,0} (172_{A,0}), is designated as relating to a future (upcoming) event, and a second file, e.g. File_{A,1} (172_{A,1}) is designated as relating to a historical event. The files are subject to NLP. As shown herein, the NL manager (152) functions to access P2P interaction event information via one or more files in the first Library_{A} (172_{A}) of the knowledge base (170).

Each of the files in the first Library_{A} (172_{A}) includes scheduling (or characteristic) data and peer identification data. The NL manager (152) applies NLP to the content of the accessed files and generates scheduling (or characteristic) data and peer-identification data. As shown in FIG. 1 by way of example, the first File_{A,0} (172_{A,0}) includes Scheduling Data_{A,0} (174_{A,0}) and Peer-Identification Data_{A,0} (176_{A,0}), and the second File_{A,1} (172_{A,1}) includes Scheduling Data_{A,1} (174_{A,1}) and Peer-Identification Data_{A,1} (176_{A,1}). The Scheduling Data_{A,0} (174_{A,0}) and the Scheduling Data_{A,1} (174_{A,1}) may include, for example, temporal data relating to the date and time of the future and historical P2P interaction events, respectively, the destination or location of the future and historical P2P interaction events, respectively, the event types of the future and historical P2P interaction events, respectively, other schedule-related information, or combinations thereof. Event types include, for example, meals (e.g., breakfast, lunch, dinner, etc.), concerts, shows, bar-related drinking and food consumption, travel, etc. The peer-identification data may include the first name and/or last name of a peer entity, such as a friend, acquaintance, colleague, family member, etc.

In an embodiment, the individual files of the second Library_{B} (172_{B}) are financial records. The library files of the second Library_{B} (172_{B}) may or may not require NLP by the NL manager (152), depending upon how the data of those library files is stored. As shown herein by way of example, a first File_{B,0} (172_{B,0}) includes Scheduling Data_{B,0} (174_{B,0}) and Financial Data_{B,0} (176_{B,0}), and a second File_{B,1} (172_{B,1}) includes Scheduling Data_{B,1} (174_{B,1}) and Financial Data_{B,1} (176_{B,1}). The Scheduling Data_{B,0} (174_{B,0}) and Scheduling Data_{B,1} (174_{B,1}) may include, for example, temporal data relating to the date and time that a debit (such as a charge) was incurred for a historical financial transaction, the destination or location that the charge for the historical financial transaction took place, the event type, etc., and combinations thereof. In exemplary embodiments, the Financial Data_{B,0} (176_{B,0}) and the Financial Data_{B,1} (176_{B,1}) includes a historical expenditure, such as a currency amount.

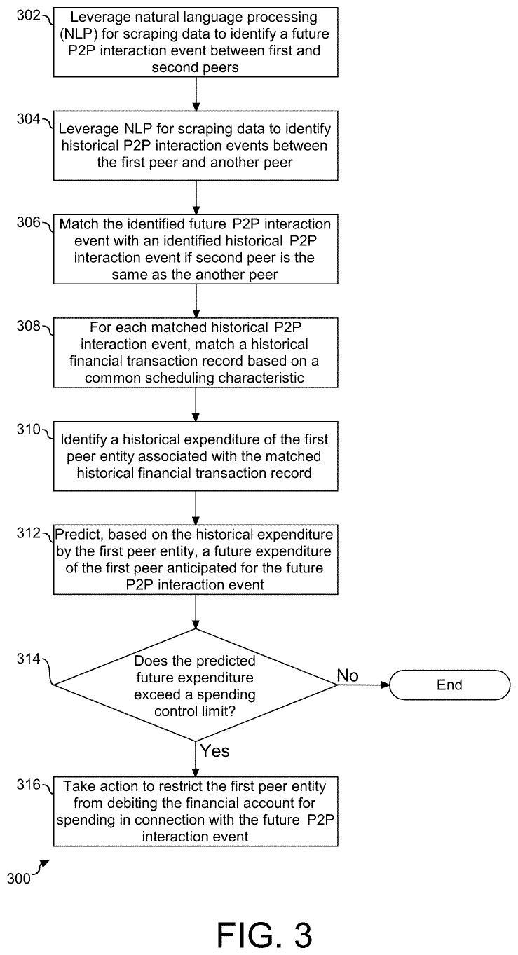

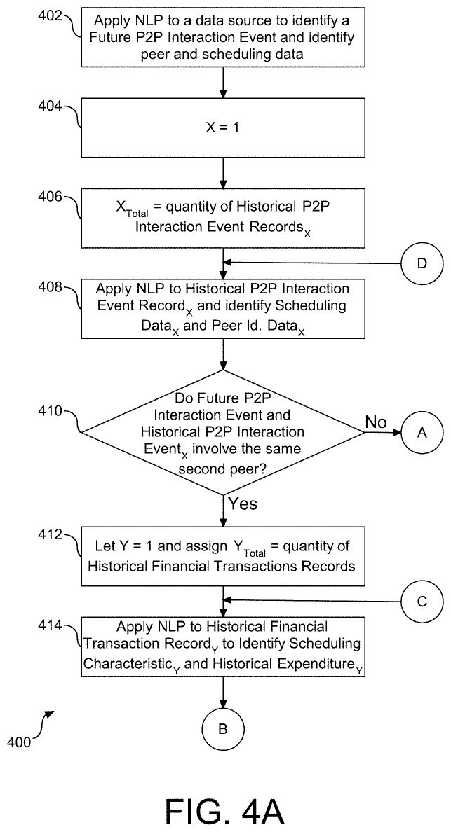

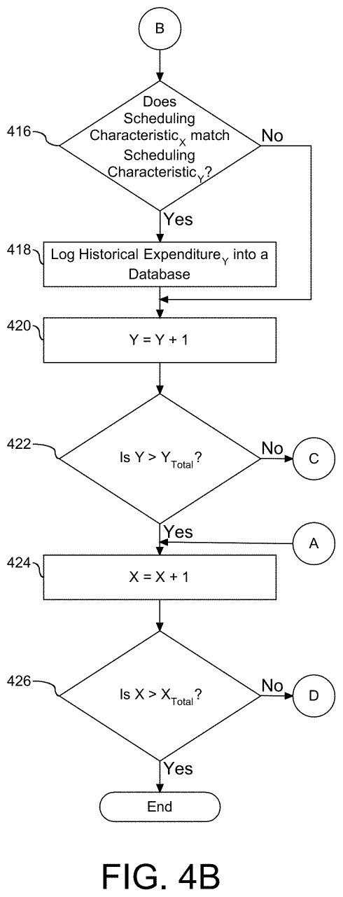

The AI manager (154), which is shown herein operatively coupled to the NL manager (152), is configured to apply AI to the P2P interaction event records and financial information records. More specifically, in an exemplary embodiment the AI manager (154) is configured to dynamically: associate the upcoming P2P interaction event with at least one historical P2P interaction event based on at least the identity of the at least one second entity; identify at least one historical financial transaction record associated with the at least one historical P2P interaction event, the at least one historical financial transaction record comprising at least one historical expenditure; predict, based on the at least one historical expenditure of the identified historical financial transaction record, a future expenditure anticipated for the upcoming P2P interaction event; and assess whether the predicted future expenditure exceeds a spending control limit. A director selectively fiscally restricts the first peer entity with respect to the financial account in connection with the upcoming P2P interaction event responsive to the predicted assessment. Details of the leveraging of the AI platform are shown in FIGS. 3, 4A, and 4B and described in greater detail below in connection with those figures.

As shown in FIG. 1, a financial institution server (140) is operatively coupled to the server (110) with a supporting dynamic spending-control platform (142). Although financial institution server (140) is shown as a separate device, it should be understood that the financial institution server (140) may be any one or more of (180), (182), (184), (186), (188), and (190). In an embodiment, the financial institution server (140) and the dynamic spending control platform (142) may be local to one or more of the computing devices operatively coupled to the server (110) across the network (105). The director (156), which is operatively coupled to the AI manager (154), generates output data (144) based on the action to fiscally restrict the first peer (e.g., limit or decline debiting of the financial account) and conveys the output data (144) on the associated platform (142) as an instruction(s) for the financial institution to take action to restrict a fiscal transaction associated with the financial account. As referred to herein, such fiscal restrictions includes such actions as debiting, charging, withdrawing, billing, or otherwise incurring a debt or obligation for current or future payment with respect to the financial account.

The director (156) also generates output data, for example, in the form of a notification or action restricting the user from using the device (180), (182), (184), (186), (188), or (190) for incurring the charge or debit. The director (156) transmits the notification and any other restriction to the first peer, for example, at device (180), (182), (184), (186), (188), or (190). Accordingly, the AI platform (150) interfaces with the knowledge base (170), the dynamic spending-control platform (142), and any one or more of devices (180), (182), (184), (186), (188), and (190) to dynamically take action to fiscally restrict the first peer with respect to the financial account in association with the upcoming P2P interaction event.

The AI platform (150) is configured to access multiple historical P2P interaction events involving the first peer entity, and multiple historical financial records associated with the historical P2P interaction events. A large quantity of historical P2P interaction event records and a large quantity of historical financial records strengthens the value of the records for prediction purposes, and in an embodiment allows discounting of (e.g., disregarding or assigning less weight to) one or more records, such as financial records associated with financial expenditures that are “outliers” to the expenditures of other financial records.

The NL manager (152) subjects the files of the first Library_{A} (172_{A}) to NLP to monitor for and identify a future P2P interaction event between the first peer entity and at least one second peer entity, and to identify the second peer entity of the future P2P interaction event. In an exemplary embodiment, the NL manager (152) also identifies at least one scheduling characteristic of the future P2P interaction event. In an exemplary embodiment, the scheduling information includes the time (e.g., date, hour) of the future P2P interaction event. In another exemplary embodiment, the scheduling information includes the location of the future P2P interaction event or the location at which the peer entities will meet. In still another exemplary embodiment, the scheduling information includes the event type. In a further exemplary embodiment, the scheduling information includes more than one characteristic of the future P2P interaction event.

The NL manager (152) also subjects the historical P2P interaction event records of the first Library_{A} (172_{A}) to NLP, so that the AI platform (150) can identify those historical P2P interaction event records that are associated with the same second peer entity as the second peer entity of the future P2P interaction event. In an exemplary embodiment, the NL manager (152) also identifies at least one scheduling characteristic of the historical P2P interaction event. In an exemplary embodiment, the scheduling information includes the time (e.g., date, hour) of the historical P2P interaction event. In another exemplary embodiment, the scheduling information includes the location of the historical P2P interaction event or the physical location at which the peer entities met. In still another exemplary embodiment, the scheduling information includes the event type. In a further exemplary embodiment, the scheduling information includes more than one characteristic of the historical P2P interaction event.

As briefly described above, the AI manager (154) supports and enables dynamic processing. In an exemplary embodiment, the AI manager (154) identifies the P2P interaction events as either future P2P interaction events or historical P2P interaction events. For example, the first Library_{A} (172_{A}) may include a first File_{A,0} (172_{A,0}) with associated Scheduling Data_{A,0} (174_{A,0}) and Peer-Identification Data_{A,0} (176_{A,0}), wherein the Scheduling Data_{A,0} (174_{A,0}) indicates that the first File_{A,0} (172_{A,0}) relates to a future P2P interaction event. The first Library_{A} (172_{A}) may also include a second File_{A,1} (172_{A,1}) with associated Scheduling Data_{A,1} (174_{A,1}) and Peer-Identification Data_{A,1} (176_{A,1}), wherein the Scheduling Data_{A,1} (174_{A,1}) indicates that the second File_{A,1} (172_{A,1}) relates to a historical (past) P2P interaction event. The search for files associated with future P2P interaction events and the historical P2P interaction events may be limited to a single library, e.g., the first library_{A} (172_{A}), or may span two or more libraries. The future and historical P2P interaction events may be stored in the same library or in different libraries.

The AI manager (154) associates the future P2P interaction event with at least one historical P2P interaction event based on at least the common identity of the second peer entity. In the above-described embodiment, the Peer-Identification Data_{A,0} (176_{A,0}) of the first File_{A,0} (172_{A,0}) may match the Peer-Identification Data_{A,1} (176_{A,1}) of the second File_{A,1} (172_{A,1}), e.g., second peers with the same first and last names. Accordingly, in the above example, the Peer-Identification Data_{A,0} (176_{A,0}) of the first File_{A,0} (172_{A,0}) associated with a future P2P interaction event identifies the same second peer entity as the Peer-Identification Data_{A,1} (176_{A,1}) of the second File_{A,1} (172_{A,1}) associated with a historical interaction event.

Each matching historical P2P interaction event file (that is, historical P2P interaction event files that identify the second peer entity in the peer identification data) has scheduling data or characteristics. As discussed above, the scheduling data (or characteristics) of the historical P2P interaction file may be, for example, temporal information (e.g., the time and date of the event), the location of the event, the event type, etc. In the embodiment illustrated in FIG. 1, the second File_{A,1} (172_{A,1}) has Scheduling Data_{A,1} (174_{A,1}). AI manager (154) applies AI to search the files of the second Library_{B} (172_{B}) (or the files of multiple second libraries) and identify at least one historical financial transaction record associated with the historical P2P interaction event by matching Scheduling Data_{A,1} (174_{A,1}) of the second File_{A,1} (172_{A,1}) of the first Library_{A} (172_{A}) with scheduling data of a file of the second Library_{B} (172_{B}).

According to an embodiment, the AI manager applies AI to search the files of the second Library_{B} (172_{B}) until one or more files are located, e.g., File_{B,0} (172_{B,0}) and/or File_{B,1} (172_{B,1}), having associated scheduling data (174_{B,0}) and (174_{B,1}) that match the Scheduling Data_{A,1} (174_{A,1}) of the second File_{A,0} (172_{A,1}). Matching may involve identical or similar temporal data, identical or similar location data, and/or identical or similar event types. If the match is made, the Financial Data_{B,0} (176_{B,0}) record of the File_{B,0} (172_{B,0}) and the Financial Data_{B,1} (176_{B,1}) record of the File_{B,1} (176_{B,1}) are used to predict a future expenditure anticipated for the identified future P2P interaction event. The Financial Data (176_{B,0}) and (176_{B,1}) may include historical expenditures, e.g., the amount of money charged or debited from the financial account. In an exemplary embodiment, the financial account may comprise more than one financial account, e.g., a banking account and a brokerage account, with the search for matching records being conducted over the multiple accounts.

The AI manager (154) predicts, based on the historical expenditures associated with the matching Financial Data (176_{B,0}) and (176_{B,1}), a future expenditure anticipated for the future P2P interaction event. Each of the historical P2P interaction events may be matched with one or more financial files. That is, the scheduling data of a historical P2P interaction event of the File_{A,1} (172_{A,1}) may match the scheduling data of multiple financial files, e.g., File_{B,0} (172_{B,0}) and File_{B,1} (172_{B,1}) of Library_{B} (172_{B}). For example, in the case of a historical P2P interaction event between the first and second peers on a prior date, the first peer may have incurred historical expenditures in connection with parking and food. In such an event, the Financial Data_{B,0} (176_{B,0}) associated with the parking and the Financial Data_{B,1} (176_{B,1}) associated with the food may be summed to determine the total expenditure associated with the historical P2P interaction event of the File_{A,1} (172_{A,1}).

Further, there may be multiple historical P2P interaction events with the same second peer entity as the future P2P interaction event. According to an embodiment, the AI manager (154) makes a prediction based on the historical expenditures associated with each of those multiple historical P2P interaction events involving the second peer entity. The prediction may involve, for example, taking the mean, median, root mean square (RMS), or other permutation of the historical expenditures. Optionally, financial record outliers (e.g., more than one, two, three, etc. standard deviations) may be discounted or ignored.

An assessment is made whether the predicted future expenditure for the future P2P interaction event exceeds a spending control limit. In an embodiment, the spending control limit may be set by the first peer entity, the financial institution, using the AI, or by others. In an embodiment, the spending control limit may be calculated, e.g., based on a percent of available funds. Different spending control limits may be set for different second peer entities.

If the predicted future expenditure anticipated for the future P2P interaction event exceeds the spending control limit, the director (156) takes action to fiscally restrict the first peer entity with respect to the financial account in connection with the future P2P interaction event. The restriction action may be embodied in various forms or combinations of various forms. According to an embodiment, the action may involve sending a notification to the visual display, such as to the first peer entity's mobile phone (180). The notification may be sent via email, text, instant message, other Internet application, or any other type of communication available for contacting the first peer entity. The action may involve sending an audio, video, or audio-video notification. The notification may inform the first peer entity that a limitation has been placed on the amount to be debited or charged from the financial account, or that any debit or charge for the future P2P interaction event will be declined. According to another embodiment, the action may involve notifying the financial institution at which the financial account is located or managed to limit the amount debited or charged to the financial account to the spending control limit or some other amount, to decline charges to the financial account, or to decline all charges to the financial account exceeding the spending control limit or some other amount. Notification of the action may be sent to the financial institution by any of the forms of communication described above, e.g., via email, text, voice message, instant message, Internet application, or any other type of communication.

The AI platform (150) may be leveraged to determine when to transmit the notification and/or instructions to the financial institution to fiscally restrict the first peer entity with respect to the financial account. As noted above, the AI platform (150) may determine the time and/or the location of the future expenditure based on the scheduling data associated with the future P2P interaction event. In an embodiment, director (156) transmits a notification to the first peer entity and/or transmits instructions to the peer entity and/or the financial institution to fiscally restrict of the peer entity with respect to the financial account at the scheduled time and/or the scheduled location of the future P2P interaction event as indicated in the corresponding file, e.g., File_{A,0} (172_{A,0}). According to another embodiment, the AI platform (150) uses a global positioning system (GPS) to detect when the first peer entity is proximately positioned to the scheduled location to take the fiscal restricting action. According to another embodiment, the AI platform (150) uses GPS to detect when the first peer entity is proximately positioned to the second peer entity, who may also be tracked with GPS. The director (156) is leveraged to take the spending restriction action when the peer entities are detected to be proximately positioned to one another or to the scheduled location.

In exemplary embodiments, the knowledge base (170) is configured with a library of data and records, represented herein as files, including scheduling data, peer identification data, and/or financial data. In an embodiment, one or more of the libraries (172_{A}) and (172_{B}) may be distributed across the computer network (105). Accordingly, the AI platform (150) and the corresponding tools (152), (154), and (156) are operatively coupled to the knowledge base (170) and the corresponding scheduling data, peer identification data, and/or financial data. In an embodiment, the knowledge base (170) may be configured with other or additional sources of input, and as such, the sources of input shown and described herein should not be considered limiting. Similarly, in an embodiment, the knowledge base (170) includes structured, semi-structured, and/or unstructured content in a plurality of documents that are contained in one or more databases or corpus. The various computing devices (180), (182), (184), (186), and (188) in communication with the network (105) may include access points for content creators and content users. Some of the computing devices (180), (182), (184), (186), and (188) may include devices for a database storing the corpus of data as the body of information used by the AI platform (150) to generate the output data, including the notification to the first peer entity and the output data (144), and to communicate the output data to the financial institution server (140) operatively coupled to the server (110) and to the first peer entity via one or more of the computing devices (180), (182), (184), (186), and (188) across network connection (104).

The network (105) may include local network connections and remote connections in various embodiments, such that the artificial intelligence platform (150) may operate in environments of any size, including local and global, e.g., the Internet. Additionally, the AI platform (150) serves as a back-end system that can make available a variety of knowledge extracted from or represented in documents, network accessible sources and/or structured data sources. In this manner, some processes populate the AI platform (150), with the AI platform (150) also including input interfaces to receive requests and respond accordingly.

As shown, content may be in the form of one or more electronic documents, shown herein as File_{A,0} (172_{A,0}), File_{A,1} (172_{A,1}), File_{B,1} (172_{B,1}), and File_{B,1} (172_{B,1}), which may be, for example, data source entries or records, for use as part of the corpus (170) of data with the AI platform (150). The corpus (170) may include any structured and/or unstructured documents, including but not limited to any file, text, email, calendared event, or source of data for use by the artificial intelligence platform (150). Content users may access the AI platform (150) via a network connection or an Internet connection to the network (105), and may submit natural language input to the AI platform (150) that may effectively be processed into context-based word(s), phrase(s), sentence(s), document(s), or vector representation. As further described below, the NLP functions to process NL and generate machine-readable data.

Context in the form of peer identification data, scheduling data, and financial expenditure data is communicated to the AI platform (150), so that the context may be interpreted and utilized by the AI platform (150). As shown, the AI platform (150) is local to the server (110). In illustrative embodiments, the server (110) may be the IBM Watson® system available from International Business Machines Corporation of Armonk, N.Y., augmented with the mechanisms of the illustrative embodiments described hereafter. The AI platform (150) is shown in FIG. 1 configured to receive input across the computer network (105) and leverage the data source or knowledge base (170) to support content detection and processing. As shown, the AI platform (150) utilizes tools, including the NL manager (152), the AI manager (154), and the director (156). Though shown as being embodied in or integrated with the server (110), the AI platform (150) and the associated managers (152) and (154), and the director (156) may be implemented in a separate computing system (e.g., the server 190) or systems that is/are connected across the network (105) to the server (110). Wherever embodied, the managers (152) and (154) and the director (156) function to provide and assess contextual analysis and AI modeling.

It is understood that the AI platform (150) leverages data from the knowledge base (170). The knowledge base (170) may be configured with domains and logically grouped activity data in the form of model(s), structure(s), and/or module(s).

The NL manager (152) may receive peer identification data, scheduling data, and financial expenditure data from sources other than the knowledge base (170), including the various computing devices (180), (182), (184), (186), (188), and (190) in communication with the computer network (105). Once the peer identification data, the scheduling data, and the financial expenditure data are received, the NL manager (152) functions to subject the received file, e.g., File_{A,1} (172_{A,1}), to NLP. In one embodiment, the NLP converts the data to one or more vectors, with the one or more vectors representing a numerical profile of two or more document characteristics.

Types of information handling systems that can utilize the server (110) range from small handheld devices, such as the handheld computer/mobile telephone (180) to large mainframe systems, such as the mainframe computer (182). Examples of the handheld computer (180) include personal digital assistants (PDAs), personal entertainment devices, such as MP4 players, portable televisions, and compact disc players. Other examples of information handling systems include the tablet (with or without a pen) computer (184), the laptop or notebook computer (186), the personal computer (188), and the server (190). As shown, the various information handling systems can be networked together using the computer network (105). Types of computer networks (105) that can be used to interconnect the various information handling systems include Local Area Networks (LANs), Wireless Local Area Networks (WLANs), the Internet, the Public Switched Telephone Network (PSTN), other wire and wireless networks, and any other network topology that can be used to interconnect the information handling systems. Many of the information handling systems include nonvolatile data stores, such as hard drives and/or nonvolatile memory. Some of the information handling systems may use separate nonvolatile data stores (e.g., the server (190) utilizes the nonvolatile data store (190_{A}), and the mainframe computer (182) utilizes the nonvolatile data store (182_{A})). The nonvolatile data stores (182_{A}) and/or (190_{A}) can be a component that is external to the various information handling systems or can be internal to one of the information handling systems.

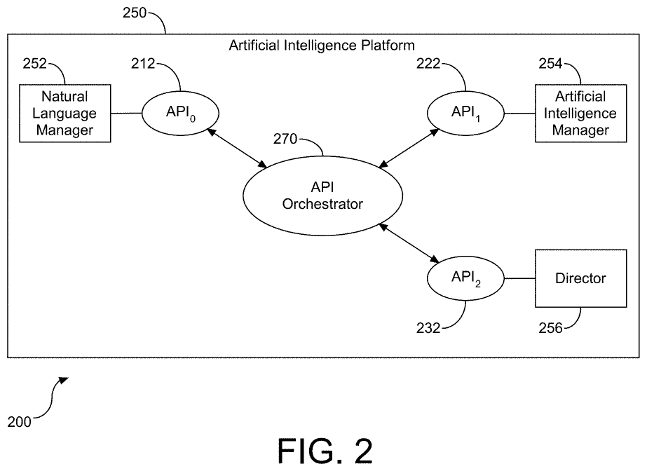

An Application Program Interface (API) is understood in the art as a software intermediary between two or more applications. With respect to the AI platform (150) shown and described in FIG. 1, one or more APIs may be utilized to support one or more of the tools (152), (154), and (156), shown herein as tools (252), (254), and (256), respectively, and their associated functionality. Referring to FIG. 2, a block diagram (200) is provided illustrating the tools (252), (254), and (256) and their associated APIs. As shown, a plurality of tools is embedded within the AI platform (205), with the tools including the natural language manager (152) shown in FIG. 2 as (252) associated with API₀ (212), the artificial intelligence manager (154) shown in FIG. 2 as (254) associated with API₀ (222), and the director (156) shown in FIG. 2 as (256) associated with API₂ (232).

Each of the APIs may be implemented in one or more languages and interface specifications. API₀ (212) provides functional support to receive and process natural language, such as, but not limited to, scheduling information and peer identification information, and generates corresponding data; API₁ (222) provides functional support to apply Artificial Intelligence to the generated data, including dynamic identification and assessment thereof; API₂ (232) provides functional support to generate output data based on the dynamic prediction of the future expenditure in relation to at least one historical expenditure. As shown, each of the APIs (212), (222), and (232) are operatively coupled to an API orchestrator (270), otherwise known as an orchestration layer, which is understood in the art to function as an abstraction layer to transparently thread together the separate APIs. In one embodiment, the functionality of the separate APIs may be joined or combined. As such, the configuration of the APIs shown herein should not be considered limiting. Accordingly, as shown herein, the functionality of the tools may be embodied or supported by their respective APIs.

Referring to FIG. 3, a flowchart (300) illustrates an overall process (or method) according to an exemplary embodiment. The process involves leveraging natural language processing (NLP) for scraping a data source to monitor for and identify a future peer-to-peer (P2P) interaction event between a first peer entity associated with a financial account and at least one second peer entity (302). The leveraging at step (302) may further comprise identifying the identity of the at least one second peer entity of the future P2P interaction event, and identifying one or more scheduling characteristics of the future P2P interaction event. The data source may comprise, for example, a single database, a single data set, a plurality of databases, or a plurality of data sets. For example, the database(s) and data set(s) may be associated an electronic calendar, text messages, email messages, application messaging, social media communications and postings, etc.

The flowchart (300) further includes leveraging NLP for scraping a data source to identify a historical peer-to-peer (P2P) interaction event between the first peer entity and one or more other peer entities, at least one of which is the at least one second peer entity, (304). The leveraging at step (304) may further comprise identifying the identity of the at least other peer entity for each of the historical P2P interaction events, and identifying one or more scheduling characteristics for each of the historical P2P interaction events. The data source may comprise, for example, any of the data sources described above in connection with leveraging at step (302). The leveraging of data sources at steps (302) and (304) may be the same or different from one another.

As further shown, the identified future P2P interaction event from step (302) are subject to matching or associating with an identified historical P2P interaction event from step (304). According to an embodiment, the matching of step (306) occurs if second peer entities of the future P2P interaction event identified in step (302) and the historic P2P interaction event identified in step (304) are the same, e.g., the peer entities have the same first and last names. In the event that the at least one second peer entity of the future P2P interaction event identified in step (302) involves multiple second peer entities (e.g., Adam, Bill, and Carly), step (306) may comprise matching all historical P2P interaction events that include any one or more of those multiple second peer entities (e.g., Adam, Bill, and/or Carly). According to an embodiment, the AI platform (150) is employed to carry out the matching at step (306).

The flowchart (300) further includes matching the historical P2P interaction event with a historical financial transaction record (308) for each historical P2P interaction event that is matched with the future P2P interaction event in step (306). According to an embodiment, the matching step (308) is performed using the AI platform (150). According to an embodiment, the matching of step (308) occurs if at least one scheduling characteristic of the historical P2P interaction event matches at least one scheduling characteristic of the historical financial transaction record. The scheduling characteristic may be, for example, a common location, time, event, etc. For example, if the historical financial P2P interaction event took place at 6 p.m. on January 1 at ABC theater, the matching in step (308) may involve finding a historical financial transaction record for a transaction that took place during or shortly after 6 p.m. on January 1 and/or involved payment to ABC theater.

Following step (308), at least one of the first peer's financial expenditures associated with the matched historical transaction record is identified (310). According to an embodiment, the identifying of the associated financial expenditure(s) in step (310) is performed using the AI platform, e.g. (150). According to an embodiment, the expenditure is a monetary amount, such as U.S. dollars or foreign currency.

The flowchart (300) further includes predicting, based on the historical expenditure identified in step (310), a future expenditure of the first peer entity anticipated for the future P2P interaction event (312), as identified in step (302). According to an embodiment, the predicting step (312) is performed using the AI platform, e.g. (150). The prediction step (312) may involve, for example, taking the mean, median, root mean square (RMS), or other permutation of the historical expenditures.

Following the prediction action at step (312), a decision or assessment is made to determine whether the future expenditure predicted in step (312) exceeds a spending control limit. According to an embodiment, the decision step (314) is performed using the AI platform. If the assessment in step (314) is that the predicted future expenditure does not exceed the spending control limit, as shown herein with a negative response to the determination at step (314), the predicted future expenditure is within allowable tolerances and no fiscal-restricting action is taken.

On the other hand, if the assessment in step (314) is that the predicted future expenditure exceeds the spending control limit, as shown herein with a positive response to the determination at step (314), the predicted future expenditure is outside allowable tolerances and fiscal-restricting action is taken in step (316). The action taken in step (316) is to fiscally restrict the first peer entity with respect to the financial account in connection with the future P2P interaction event identified in step (302). According to an embodiment, the restricting step (316) is performed using the AI platform (150), more specifically by the director (156) in an exemplary embodiment. According to an embodiment, the restricting step (316) involves using one or more of the scheduling characteristics identified in step (302) to fiscally restrict the first peer entity with respect to the financial account. For example, if step (302) identified the future P2P interaction event as taking place at 6 p.m. on January 1 at ABC theater, the restricting action may be timed to take place within a period surrounding 6 p.m. on January 1, e.g., from 5 p.m. to 9 p.m., and/or to restrict debiting or charging of the financial account for spending at ABC theater. According to another embodiment, the restricting step (316) involves using GPS to determine when the first peer entity is in proximity to the second peer entity, such as by tracking the mobile devices (e.g., phones) of the peer entities, and restricting debiting, charging, etc. of the financial account while the peer entities remain in proximity to one another.

FIGS. 4A and 4B illustrate a flowchart of an exemplary method for carrying out steps (302), (304), (306), (308), and (310) of flowchart (300) of FIG. 3. In step (402) of FIG. 4A, NLP is applied to a data source to identify a Future P2P Interaction Event, the scheduling data (e.g., location and time), and second peer entity identification data for the Future P2P Interaction Event.

The variable X, representing a Historical P2P Interaction Event Record, is initialized (404), followed by setting the quantity of Historical P2P Interaction Event Records to the variable X_{Total} (is set as the total number of Historical P2P Interaction Event Records_{X} (406). Following the initializations at steps (404) and (406), NLP is applied to Historical P2P Interaction Event_{X} to identify Scheduling Dataₓ and Peer Identification Data_{X} relating to Historical P2P Interaction Event Record_{X} for each of the records (408). At step (410), it is determined whether the peer identification data of the Future P2P Interaction Event and the Peer Identification Data_{X} of the Historical P2P Interaction Event Record_{X} match one another (410). If the answer at decision step (410) is negative, the Historical P2P Interaction Event Record_{X} is dismissed as irrelevant and the method proceeds to step (424) of FIG. 4B, described below. If the answer at decision step (410) is positive, a financial transaction record variable, Y, is initialized and the variable Y_{Total} is set as the total number of Historical Financial Transaction Records (412). For each financial transaction record, NLP is applied to the Historical Financial Transaction Record_{Y} to identify a Scheduling Characteristic_{Y} and a Historical Expenditure_{Y} of the Historical Financial Transaction RecordY (414).

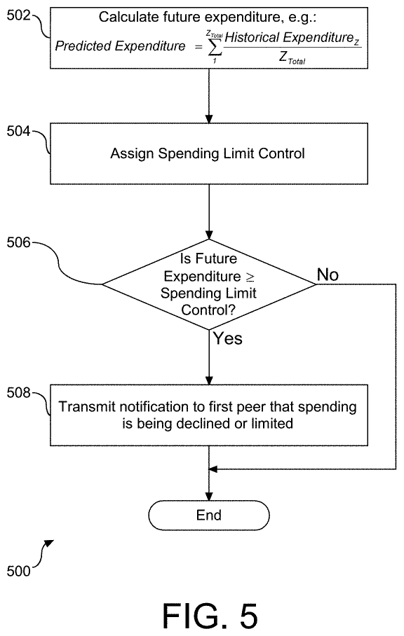

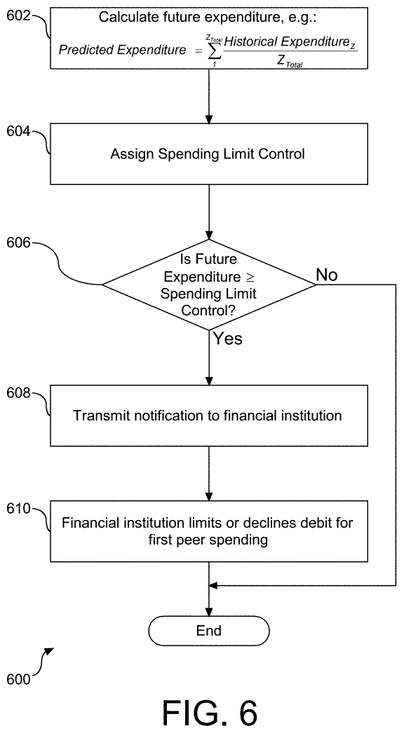

Referring now to FIG. 4B, at step (416) a decision is made whether the Scheduling Characteristic_{Y} of the Historical Financial Transaction Record_{Y} matches the Scheduling Characteristic_{X} of the Historical P2P Interaction Event Record_{X}. A negative response to the decision step (416), is followed by dismissal of the Historical Financial Transaction Record_{Y} as irrelevant and the method proceeds to step (420), described below. On the other hand, if the answer at decision step (416) is yes, the Historical Financial Transaction Record_{Y} is logged into a database (not shown) at step (418) for later use in predicting the future expenditure, as described above in connection with step (312) of FIG. 3 and steps (502) and (602) of FIGS. 5 and 6, respectively.

Following step (418) of FIG. 4B or a negative response to the determination at step (416), the financial transaction record variable Y is incremented (420), and at step (422) a decision is made whether all of the Historical Financial Transaction Records_{Y} have been considered. If the answer at decision step (422) is no, then additional Historical Financial Transaction Records_{Y} remain to be considered, and the method returns to step (414), which is applied to Historical Financial Transaction Record_{Y+1} (e.g., Historical Financial Transaction Record₂). On the other hand, if the answer at decision step (422) is yes, then no additional Historical Financial Transaction Records_{Y} remain to be considered.

The flowchart (400) of FIGS. 4A and 4B proceeds to step (424) to increment the variable corresponding to the Historical P2P Peer Interaction Record_{X}. At step (426), a decision is made whether all of the Historical P2P Interaction Event Records have been considered. If the answer at decision step (426) is no, then additional Historical P2P Interaction Event Records remain to be considered, and the method returns to step (408), which is applied to Historical P2P Interaction Event Record_{X+1} (e.g., Historical P2P Interaction Event Record₂). On the other hand, if the answer at decision step (426) is positive, then no additional Historical P2P Interaction Event Records_{X} remain to be considered, and the process ends.

FIGS. 5 and 6 illustrate flowcharts (500) and (600), respectively, providing exemplary embodiments for carrying out steps (312), (314), and (316) of FIG. 3. In steps (502) and (602), the future expenditure is predicted. According to an embodiment, the predicted future expenditure is the mean of the historical expenditures involving the first peer entity and at least one of the second peer entities, and is calculated as follows:

$$Predicted Future Expenditure = {\sum }_{1}^{NTotal} ( Historical {Expenditure}_{N} ) / {N}_{Total}$$

In other embodiments, the future expenditure may be predicted base on other computations. The future expenditure may be, for example, the median value of the Historical Expenditure) to the Historical Expenditure_{NTotal}, wherein N_{Total} is the total number of historical expenditures. According to another embodiment, different weighting may be given to the set of Historical Expenditures. According to another embodiment, matched historical expenditures that pertain to an event type or location that is similar to or the same as the event type or location of the future P2P interaction event are given greater weight or are exclusively used to predict the future expenditure. According to another embodiment, matched historical expenditures that pertain to scheduled temporal information that is similar to or the same as the temporal information for the future P2P interaction event are given greater weight or are exclusively used to predict the future expenditure. For example, if the future expenditure is to occur on New Year's Eve, historical P2P interaction events involving the first and second entities that took place on prior New Year's Eves would be given greater weight or exclusively used to predict the future expenditure.

In steps (504) and (604) of FIG. 5 and FIG. 6, respectively, the spending limit control is assigned. Various examples of spending control limits are described herein. Embodiments include assigning a predetermined spending limit based on percent of available balance, percent of gross, net, or disposable income, event type, peer entity identity, scheduled time, an arbitrary amount, etc., and combinations thereof.

In steps (506) and (606) of FIG. 5 and FIG. 6, respectively, a determination is made as to whether the future expenditure exceeds, or in one embodiment equals, a spending limit control. A description for carrying out the determination (506) and (606) is provided above in connection with the description of step (314) of FIG. 3, which description is incorporated herein by reference.

Steps (508) of FIG. 5 and steps (608) and (610) of FIG. 6 involve fiscally restricting the first peer entity with respect to the financial account in connection with the future P2P interaction event. In FIG. 5, step (508) comprises involves transmitting a notification to the first peer entity notifying the first peer entity that spending is being restricted, for example, declined or limited to a certain amount. According to an exemplary embodiment, the notification is transmitted to a device of the first peer entity, and in particular exemplary embodiments the device is a mobile device, e.g., (180), (184), or (186), that may be maintained on the person of the first peer entity, such as a mobile phone, tablet, or laptop computer.

In FIG. 6, step (608) involves transmitting notification to a financial institution that holds or asserts some degree of control over the financial account of the first peer entity. In accordance with exemplary embodiments, the notification can be to limit or decline debits or charges to the financial account in connection with spending relating to the future P2P interaction event. In step (610), the financial institution limits or declines debits or charges to the financial account in connection with spending relating to the future P2P interaction event. It should be understood that FIGS. 5 and 6 may be combined. For example, in addition to preventing debiting or charging of the financial account in steps (608) and (610) of FIG. 6, a notification may be transmitted to the first peer entity that spending will be restricted in accordance with step (508) of FIG. 5.

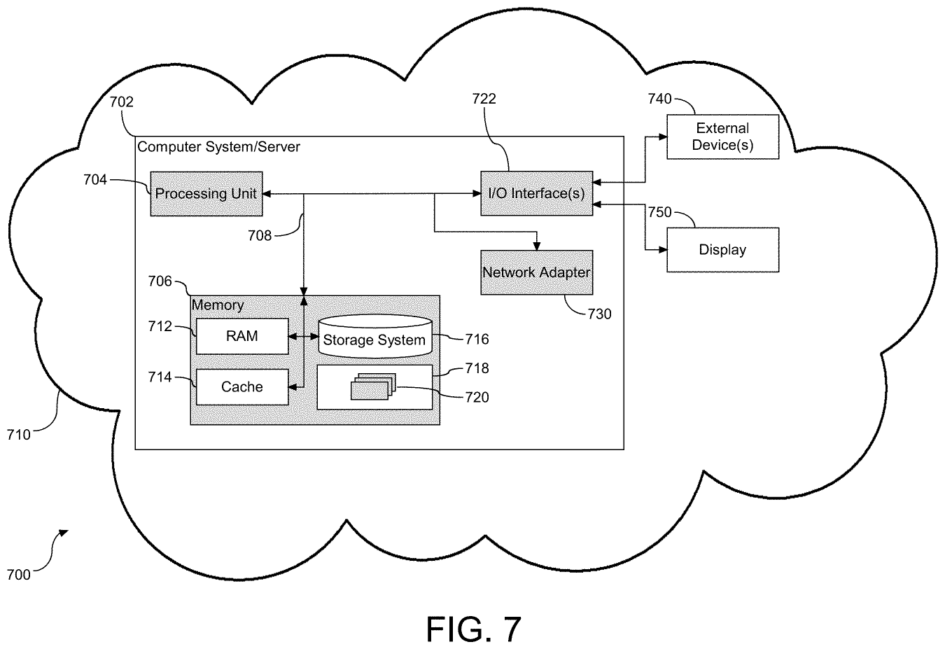

Embodiments shown and described herein may be in the form of a computer system for use with an intelligent computer platform for identifying a future P2P interaction event and historical P2P interaction events, predicting a future expenditure, and taking action to restrict spending. The embodiments and their associated functionality may be embodied in a computer system/server in a single location, or in one embodiment, may be configured in a cloud based system sharing computing resources. With reference to FIG. 7, a block diagram (700) is provided illustrating an example of a computer system/server (702), hereinafter referred to as a host (702) in a cloud computing environment (710), to implement the system, tools, and processes described above with respect to FIGS. 1-6. Host (702) is operational with numerous other general purpose or special purpose computing system environments or configurations. Examples of well-known computing systems, environments, and/or configurations that may be suitable for use with host (702) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and file systems (e.g., distributed storage environments and distributed cloud computing environments) that include any of the above systems, devices, and their equivalents.

The host (702) may be described in the general context of computer system-executable instructions, such as program modules, being executed by a computer system. Generally, program modules may include routines, programs, objects, components, logic, data structures, and so on that perform particular tasks or implement particular abstract data types. The host (702) may be practiced in distributed cloud computing environments where tasks are performed by remote processing devices that are linked through a communications network. In a distributed cloud computing environment, program modules may be located in both local and remote computer system storage media including memory storage devices.

The host (702) is shown in the form of a general-purpose computing device. The components of the host (702) may include, but are not limited to, one or more processors or processing units (704), e.g., hardware processors, a system memory (706), and a bus (708) that couples various system components including the system memory (706) to the processing unit(s) (704). The bus (708) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. The host (702) typically includes a variety of computer system readable media. Such media may be any available media that is accessible by the host (702) and it includes both volatile and non-volatile media, removable and non-removable media.

The system memory (706) can include computer system readable media in the form of volatile memory, such as random access memory (RAM) (712) and/or cache memory (714). By way of example only, storage system (716) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus (708) by one or more data media interfaces.

Program/utility (718), having a set (at least one) of program modules (720), may be stored in memory (706) by way of example, and not limitation, as well as an operating system, one or more application programs, other program modules, and program data. Each of the operating systems, one or more application programs, other program modules, and program data or some combination thereof, may include an implementation of a networking environment. Program modules (720) generally carry out the functions and/or methodologies of embodiments to dynamically provide action to manage a fiscal transaction. For example, the set of program modules (720) may include the manager (152) and (154), and the director (156) as described in FIG. 1.

Host (702) may also communicate with one or more external devices (740), such as a keyboard, a pointing device, etc.; a display (750); one or more devices that enable a user to interact with host (702); and/or any devices (e.g., network card, modem, etc.) that enable host (702) to communicate with one or more other computing devices. Such communication can occur via Input/Output (I/O) interface(s) (722). Still yet, host (702) can communicate with one or more networks such as a local area network (LAN), a general wide area network (WAN), and/or a public network (e.g., the Internet) via network adapter (730). As depicted, network adapter (730) communicates with the other components of host (702) via bus (708). In an embodiment, a plurality of nodes of a distributed file system (not shown) is in communication with the host (702) via the I/O interface (722) or via the network adapter (730). It should be understood that although not shown, other hardware and/or software components could be used in conjunction with host (702). Examples, include, but are not limited to: microcode, device drivers, redundant processing units, external disk drive arrays, RAID systems, tape drives, and data archival storage systems, etc.

In this document, the terms “computer program medium,” “computer usable medium,” and “computer readable medium” are used to generally refer to media such as main memory (706), including RAM (712), cache (714), and storage system (716), such as a removable storage drive and a hard disk installed in a hard disk drive.

Computer programs (also called computer control logic) are stored in memory (706). Computer programs may also be received via a communication interface, such as network adapter (730). Such computer programs, when run, enable the computer system to perform the features of the present embodiments as discussed herein. In particular, the computer programs, when run, enable the processing unit (704) to perform the features of the computer system. Accordingly, such computer programs represent controllers of the computer system.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the embodiments.

In an embodiment, the host (702) is a node of a cloud computing environment. As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Examples of such characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher layer of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some layer of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

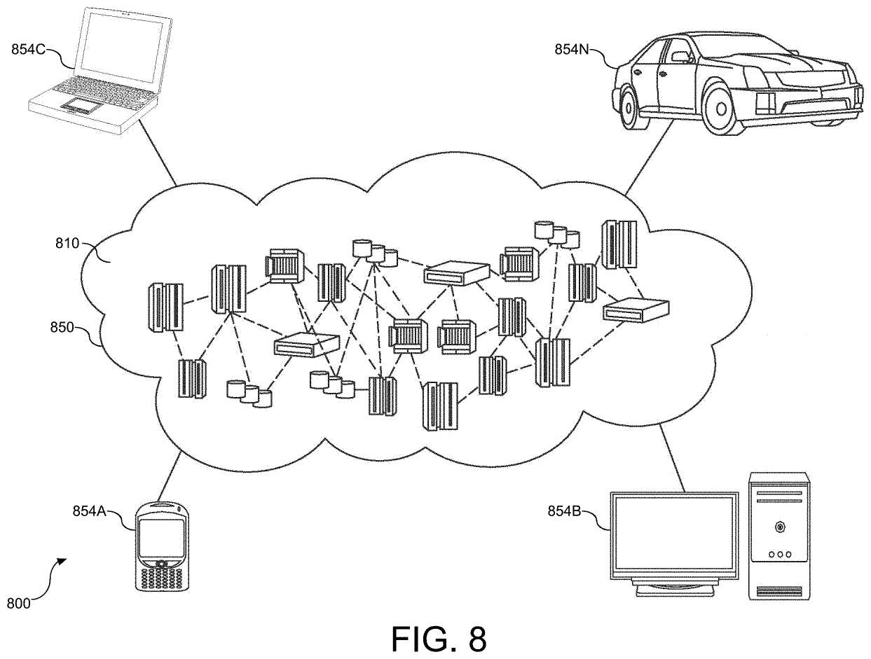

Referring now to FIG. 8, an illustrative cloud computing network (800). As shown, cloud computing network (800) includes a cloud computing environment (850) having one or more cloud computing nodes (810) with which local computing devices used by cloud consumers may communicate. Examples of these local computing devices include, but are not limited to, personal digital assistant (PDA) or cellular telephone (854A), desktop computer (854B), laptop computer (854C), and/or automobile computer system (854N). Individual nodes within nodes (810) may further communicate with one another. They may be grouped (not shown) physically or virtually, in one or more networks, such as Private, Community, Public, or Hybrid clouds as described hereinabove, or a combination thereof. This allows cloud computing environment (800) to offer infrastructure, platforms and/or software as services for which a cloud consumer does not need to maintain resources on a local computing device. It is understood that the types of computing devices (854A), (854B), (854C), and (854N) shown in FIG. 8 are intended to be illustrative only and that the cloud computing environment (850) can communicate with any type of computerized device over any type of network and/or network addressable connection (e.g., using a web browser).

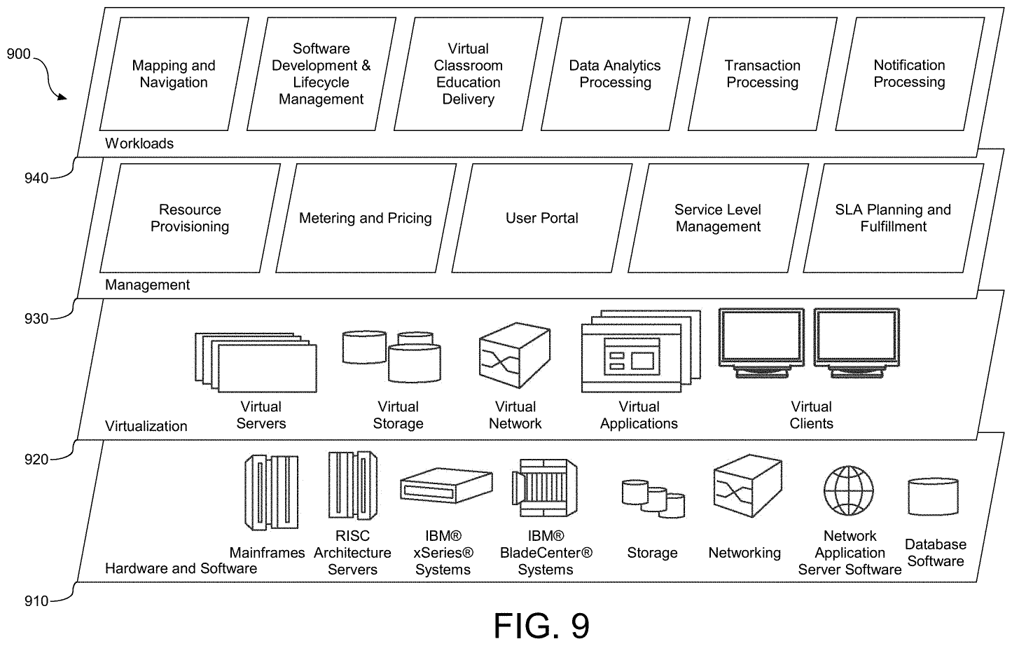

Referring now to FIG. 9, a set of functional abstraction layers (900) provided by the cloud computing network of FIG. 8 is shown. It should be understood in advance that the components, layers, and functions shown in FIG. 9 are intended to be illustrative only, and the embodiments are not limited thereto. As depicted, the following layers and corresponding functions are provided: hardware and software layer (910), virtualization layer (920), management layer (930), and workload layer (940).

The hardware and software layer (910) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (920) provides an abstraction layer from which the following examples of virtual entities may be provided: virtual servers; virtual storage; virtual networks, including virtual private networks; virtual applications and operating systems; and virtual clients.

In an example, the management layer (930) may provide the following functions: resource provisioning, metering and pricing, user portal, service layer management, and SLA planning and fulfillment. Resource provisioning provides dynamic procurement of computing resources and other resources that are utilized to perform tasks within the cloud computing environment. Metering and pricing provides cost tracking as resources are utilized within the cloud computing environment, and billing or invoicing for consumption of these resources. In an example, these resources may comprise application software licenses. Security provides identity verification for cloud consumers and tasks, as well as protection for data and other resources. User portal provides access to the cloud computing environment for consumers and system administrators. Service layer management provides cloud computing resource allocation and management such that required service layers are met. Service Layer Agreement (SLA) planning and fulfillment provides pre-arrangement for, and procurement of, cloud computing resources for which a future requirement is anticipated in accordance with an SLA.

The workload layer (940) provides examples of functionality for which the cloud computing environment may be utilized. Examples of workloads and functions which may be provided from this layer include, but are not limited to: mapping and navigation; software development and lifecycle management; virtual classroom education delivery; data analytics processing; and transaction processing.

It will be appreciated that there is disclosed herein a system, method, apparatus, and computer program product for dynamically controlling spending.

While particular embodiments of the present embodiments have been shown and described, it will be obvious to those skilled in the art that, based upon the teachings herein, changes and modifications may be made without departing from the embodiments and its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to embodiments containing only one such element, even when the same claim includes the introductory phrases “one or more” or “at least one” and indefinite articles such as “a” or “an”; the same holds true for the use in the claims of definite articles.

The present embodiments may be a system, a method, and/or a computer program product. In addition, selected aspects of the present embodiments may take the form of an entirely hardware embodiment, an entirely software embodiment (including firmware, resident software, micro-code, etc.) or an embodiment combining software and/or hardware aspects that may all generally be referred to herein as a “circuit,” “module” or “system.” Furthermore, aspects of the present embodiments may take the form of computer program product embodied in a computer readable storage medium (or media) having computer readable program instructions thereon for causing a processor to carry out aspects of the present embodiments. Thus embodied, the disclosed system, method, and/or a computer program product are operative to improve the functionality and operation of an artificial intelligence platform to support and enable dynamic content commentary evaluation.

Aspects of the present embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated that, although specific embodiments have been described herein for purposes of illustration, various modifications may be made without departing from the spirit and scope of the embodiments. Accordingly, the scope of protection of the embodiments is limited only by the following claims and their equivalents.

What is claimed is:

1. A computer system comprising:
a processing unit operatively coupled to memory; and
an artificial intelligence (AI) platform in communication with the processing unit, the AI platform comprising one or more tools to dynamically provide an action selectively restrict a fiscal transaction, comprising:
a natural language (NL) manager to scrape a data source to monitor for and identify a future peer-to-peer (P2P) interaction event between a first peer entity and at least one second peer entity, to identify the second peer entity, and to identify at least one historical P2P interaction event between the peer entities, the first peer entity having access to a financial account;
an AI manager configured to apply AI to:
associate the future P2P interaction event with the at least one historical P2P interaction event based on at least the identity of the at least one second peer entity;
identify at least one historical financial transaction record associated with the at least one historical P2P interaction event between the peer entities, the at least one historical financial transaction record associated with at least one historical P2P interaction event comprising at least one historical expenditure by the first peer entity;
predict, based on the at least one historical expenditure, a future expenditure anticipated for the future P2P interaction event; and
assess the predicted future expenditure anticipated for the future P2P interaction event with respect to a spending control limit; and
a director to selectively fiscally restrict the first peer entity with respect to the financial account in connection with the future P2P interaction event responsive to the assessed prediction.

2. The computer system of claim 1, wherein the selective fiscal restriction comprises the director to place a debit and/or charge limit on the financial account.

3. The computer system of claim 1, wherein the selective fiscal restriction comprises the director to decline a debit and/or charge to the financial account.

4. The computer system of claim 1, wherein the selective fiscal restriction comprises the director to transmit notification of the fiscal restriction to the first peer entity.

5. The computer system of claim 1, wherein:
the AI manager is configured to apply AI to use a global positioning system to detect when the peer entities are proximately positioned; and
the selective fiscal restriction comprises the director to fiscally restrict the first peer entity with respect to the financial account when the peer entities are proximately position as determined by the global positioning system.

6. The computer system of claim 1, wherein:
the NL manager identifies a characteristic of the future P2P interaction event, the characteristic comprising temporal information concerning the future P2P interaction event; and
the selective fiscal restriction of the first peer entity comprises the director to fiscally restrict the first peer entity with respect to the financial account based on the temporal information.

7. The computer system of claim 1, wherein:
the NL manager to identify a characteristic of the future P2P interaction event, the characteristic comprising destination information concerning the future P2P interaction event; and
the selective fiscal restriction comprises the director to fiscally restrict the first peer entity with respect to the financial account based on the destination information.

8. A computer program product to dynamically provide an action to selectively restrict a fiscal transaction, the computer program product comprising a computer readable storage medium having program code embodied therewith, the program code executable by a processor to:
leverage a national language processing (NLP) system for scraping a data source to monitor for and identify a future peer-to-peer (P2P) interaction event between a first peer entity and at least one second peer entity, to identify the second peer entity, and to identify at least one historical P2P interaction event between the peer entities, the first peer entity having access to a financial account;
apply artificial intelligence (AI) comprising program code to:
associate the future P2P interaction event with the at least one historical P2P interaction event based on at least the identity of the at least one second peer entity;
identify at least one historical financial transaction record associated with the at least one historical P2P interaction event between the peer entities, the at least one historical financial transaction record associated with at least one historical P2P interaction event comprising at least one historical expenditure by the first peer entity;
predict, based on the at least one historical expenditure, a future expenditure anticipated for the future P2P interaction event; and
assess whether the predicted future expenditure anticipated for the future P2P interaction event exceeds a spending control limit; and
selectively fiscally restrict the first peer entity with respect to the financial account in connection with the future P2P interaction event responsive to the assessed prediction.

9. The computer program product of claim 8, wherein the program code to selectively fiscally restrict comprises program code to place a limit on debiting and/or charging of the financial account.

10. The computer program product of claim 8, wherein the program code to selectively fiscally restrict comprises program code to decline to debit and/or charge the financial account.

11. The computer program product of claim 8, wherein the program code to selectively fiscally restrict comprises program code to transmit a notification of the fiscal restriction to the first peer entity.

12. The computer program product of claim 8, wherein:
the AI comprises program code configured to apply AI to use a global positioning system to detect when the peer entities are proximately positioned to one another; and
the program code to selectively fiscally restrict comprises program code to fiscally restrict the first peer entity with respect to the financial account when the peer entities are proximately positioned as determined by the global positioning system.

13. The computer program product of claim 8, wherein:
the NLP system comprises program code configured to identify a characteristic of the future P2P interaction event, the characteristic comprising temporal information concerning the future P2P interaction event; and
the program code to selectively fiscally restrict comprises program code to fiscally restrict the first peer entity with respect to the financial account based on the temporal information.

14. A computer-implemented method for selectively restricting a fiscal transaction, comprising:
leveraging a national language processing (NLP) system for scraping a data source to monitor for and identify a future peer-to-peer (P2P) interaction event between a first peer entity and at least one second peer entity, to identify the at least one second peer entity, and to identify at least one historical P2P interaction event between the peer entities, the first peer entity having access to a financial account;
leveraging an artificial intelligence (AI) platform to:
associate the future P2P interaction event with the at least one historical P2P interaction event based on at least the identity of the at least one second peer entity;
identify at least one historical financial transaction record associated with the at least one historical P2P interaction event between the peer entities, the at least one historical financial transaction record associated with at least one historical P2P interaction event comprising at least one historical expenditure by the first peer entity;
predict, based on the at least one historical expenditure, a future expenditure anticipated for the future P2P interaction event; and
assess whether the predicted future expenditure anticipated for the future P2P interaction event exceeds a spending control limit; and
selectively fiscally restricting the first peer entity with respect to the financial account in connection with the future P2P interaction event responsive to the assessed prediction.

15. The computer-implemented method of claim 14, wherein the selectively fiscal restricting comprises placing a limit on debiting and/or charging of the financial account.

16. The computer-implemented method of claim 14, wherein the selectively fiscal restricting comprises declining to debit and/or charge the financial account.

17. The computer-implemented method of claim 14, wherein the selectively fiscal restricting comprises transmitting a notification of the fiscal restriction to the first peer entity.

18. The computer-implemented method of claim 14, wherein:
the leveraging the AI platform further comprises using a global positioning system to detect when the peer entities are proximately positioned; and
the selectively fiscal restricting comprises fiscally restricting the first peer entity with respect to the financial account when the peer entities are proximately positioned as determined by the global positioning system.

19. The computer-implemented method of claim 14, wherein:
the leveraging the NLP system further comprises identifying a characteristic of the future P2P interaction event, the characteristic comprising temporal information concerning the future P2P interaction event; and
the selectively fiscal restricting comprises fiscally restricting the first peer entity with respect to the financial account based on the temporal information.

20. The computer-implemented method of claim 14, wherein:
the leveraging the NLP system further comprises identifying a characteristic of the future P2P interaction event, the characteristic comprising destination information concerning the future P2P interaction event; and
the selectively fiscal restricting comprises fiscally restricting the first peer entity with respect to the financial account based on the destination information.
